(19) United States
(12) Patent Application Publication
(10) Pub. No.: US 2024/0166806 A1
(43) Pub. Date: May 23, 2024

(54) PROCESS OF CONTINUOUSLY MANUFACTURING A POLY(HYDROXY ACID) COPOLYMER WITH TUNABLE MOLECULAR WEIGHT, STRUCTURE AND COMPOSITION

(71) Applicant: SULZER MANAGEMENT AG, Winterthur (CH)

(72) Inventors: Ho Ting Harris LUK, Effretikon (CH); Matteo MARALDI, Milan (IT)

(21) Appl. No.: 18/282,470

(22) PCT Filed: Mar. 17, 2022
(86) PCT No.: PCT/EP2022/057011

§ 371 Date: Sep. 15, 2023

(30) Foreign Application Priority Data
Mar. 18, 2021 (EP) 21163462.1

(51) Int. Cl. C08G 63/78; C08G 63/08

(52) U.S. Cl. CPC C08G 63/785; C08G 63/08

(57) ABSTRACT

A process of continuously manufacturing a poly(hydroxy acid) copolymer is provided. The process comprises copolymerizing at least two different monomers in the presence of a catalyst in a reactor system by ring-opening-polymerization. At least one of the monomers is a cyclic ester of hydroxy acid. A molar ratio of a total amount of the different monomers to a total amount of the at least one catalyst is more than 10,000. The reactor system comprises in series at least two polymerization reactors including a continuous stirred-tank reactor, a loop reactor or a plug flow reactor, one of the reactors comprising at least one of a mixer and a heat transfer element. The reactor system comprises at least two different feeding points through each of which a monomer composition is fed. A first monomer composition fed through one feeding point is different from a second monomer composition fed through another feeding point.

### CROSS-REFERENCE TO RELATED APPLICATION

This application is a U.S. National Stage application of International Application No. PCT/EP2022/057011, filed Mar. 17, 2022, which claims priority to European Application No. 21163462.1, the contents of each of which are hereby incorporated by reference.

### BACKGROUND

### Technical Field

The present disclosure relates to a process of continuously manufacturing a poly(hydroxy acid) copolymer by copolymerizing at least two different monomers, wherein at least one of the at least two different monomers is a cyclic ester of hydroxy acid, in the presence of at least one catalyst and optionally one initiator by ring-opening-polymerization.

### Background of the Invention

Poly(hydroxy acid) polymers are of particular interest, because they can be obtained from renewable resources and are mostly compostable and/or biodegradable. Moreover, the technological properties of these polymers come quite close to the properties of those polymers derived from fossil-based resources, which explains why these polymers are regarded as highly promising substitutes for the latter. One example for a commercially important poly(hydroxy acid) homopolymer is polylactic acid, which is based on an α-hydroxy acid lactic acid and which has a wide range of applications. For instance, polylactic acid is used in the biomedical field in chirurgical implants, in films, such as e.g. in packaging, in fibers, such as e.g. for garments, in hygienic articles, in carpets and in disposable plastic products, such as e.g. disposable cutlery or containers. Moreover, polylactic acid has found wide application in composite materials, such as in fiber-reinforced plastics. Another important example for a respective poly(hydroxy acid) homopolymer is polycaprolactone, which is derived from a cyclic ester, caprolactone, originated from the intramolecular esterification of hydroxy acid caprolic acid. This polymer finds widespread applications in the production of specialty polyurethanes and is characterized by a good resistance to water, to oil and to solvent. Other examples are polyglycolic acid, polyvalerolactone and the like. Poly(hydroxy acid) copolymers are interesting alternatives, since by appropriate selection of the comonomers and their relative amounts to each other and by adjusting an appropriate molecular weight, certain properties of the copolymers can be tailored to the intended use. One example for such a copolymer is poly(lactide-co-caprolactone). Polylactic acid is known for its high strength and stiffness, but it suffers from poor elasticity, toughness and impact resistance. Due to the incorporation of caprolactone as comonomer the resulting copolymer shows a controllable elasticity and excellent resistance to creep. Another important example for a respective poly(hydroxy acid) copolymer is poly(lactide-co-glycolide). Another disadvantage of polylactic acid lies on its low biodegradation rate. The addition of glycolide enhances the hydrolytic degradation rate and enables the tuning of hydrophobic/hydrophilic balance, which in turn changes its field of application. The higher melting temperature of poly(lactide-co-glycolide) also broadens its application for high temperature applications.

### SUMMARY

Generally, two alternative principal methods are known for synthesizing poly(hydroxy acid) copolymers. The first principal method is the direct polycondensation of two or more aliphatic hydroxy acid(s) to the respective copolymer, such as the direct polycondensation of lactic acid and glycolic acid to poly(lactide-co-glycolide). However, this principal method only leads to low molecular weight copolymers and is thus limited to specific copolymers. The second principal method is the ring-opening-polymerization of two or more cyclic esters of hydroxy acid(s), such as the ring-opening-polymerization of lactide (which is the cyclic diester of lactic acid), glycolide (which is the cyclic diester of glycolic acid), lactones or the like. This is the preferred method nowadays for the industrial production of poly(hydroxy acid) copolymers. The cyclic diesters can be produced by intramolecular esterification of an aliphatic hydroxy acid, such as in the case of a lactone, for instance caprolactone, or by condensation of two hydroxy acid molecules into a cyclic diester, such as condensation of lactic acid to lactide or condensation of glycolic acid to glycolide. Alternatively, the cyclic esters, such as in particular cyclic diesters can be produced by first oligomerizing a hydroxy acid and then subjecting the oligomer to a depolymerization reaction in order to obtain the cyclic diester. For instance, lactide is often prepared by the latter method, for instance by fermentation of carbohydrates from biomass, such as starch, sugar or corn resulting in lactic acid, by then oligomerizing the lactic acid and by afterwards subjecting the oligomers to a depolymerization reaction in order to obtain lactide. After purification, the two or more cyclic esters of hydroxy acid as monomer(s) are then copolymerized in the presence of a catalyst and optionally an initiator to form high molecular weight copolymer. The unreacted cyclic esters have to be removed after the polymerization to a final concentration of less than at least 0.5% by weight, in order to obtain a product of marketable quality. Such a removal of unreacted cyclic esters can be achieved for instance in the case of lactide by means of at least one devolatilization step conducted at elevated temperature and reduced pressure. For example, a two-stage devolatilization process can be performed in order to obtain the required degree of lactide removal and thus to obtain a polymer having the required quality. In order to terminate the polymerization reaction, an inhibitor is usually added to the polymeric product at the end of the polymerization and before or after the first devolatilization step. Alternatively, residual monomers can be removed by dissolving the monomer and polymer mixture in a solvent such as 1,1,1,3,3,3-hexafluoro-2-propanol (HFIP), dichloromethane (DCM) and chloroform and reprecipitate the monomer-free polymer with an antisolvent such as methanol, acetone and hexane. Still, this latter method is less preferable in an industrial scale, considering the heavy solvent consumption and long dissolution time.

Thus, a process of preparing for instance poly(lactide-co-glycolide) can comprise the steps of i) carrying out a ring-opening-polymerization of lactide in the presence of a catalyst for ring-opening-polymerization of the lactide to polylactic acid and then reacting the polylactic acid in a ring-opening-polymerization with glycolide in the presence of a respective catalyst to poly(lactide-co-glycolide) block copolymer or carrying out a ring-opening-polymerization of lactide and of glycolide in the presence of respective catalysts for ring-opening-polymerization of the lactide and of the glycolide to poly(lactide-co-glycolide) random or block copolymer, ii) adding to each of the reaction mixture a compound capable of deactivating the catalyst(s) and iii) reducing the pressure in the reactor(s) containing reaction mixture and/or allowing an inert gas to pass through the respective reactor(s) to remove unreacted lactide and unreacted glycolide from the copolymer by devolatilization. Usually, two subsequent devolatilization steps are performed and the vapor streams enriched in lactide or glycolide, respectively, are recycled to the respective polymerization reactor.

A major drawback of the current processes of preparing poly(hydroxy acid) copolymers, regardless of ring-opening polymerization or polycondensation, is that they require, in particular if copolymers with comparably high molecular weight and/or copolymers with a branched structure shall be prepared, a long reaction time of 8 to 24 hours or even up to 72 hours. Moreover, usually comparably high amounts of catalyst, namely between 300 and 10,000 ppm (equivalent to the molar ratio of the total amount of the two or more monomers, i.e. cyclic esters, to the total amount of the at least one catalyst applied between 280 and 9000), are required. In addition, the commercial industrial processes of preparing poly(hydroxy acid) copolymers are mostly batch processes. Another important drawback is that the processes are not flexible enough to enable an easy transition from the production of a certain copolymer with a certain molecular weight and structure to another copolymer of the same type, but with a different molecular weight and structure. Furthermore, the copolymerization of monomers having vastly different reactivity ratios would lead to an uncontrolled polymer structure (i.e. a mixture of random, statistical and block copolymers in a single polymer chain), which ultimately influences the properties of the material. Even though certain continuous processes were proposed, they either required the use of (supercritical) solvent carrier (as in U.S. Pat. No. 9,346,915B2 and in U.S. Pat. No. 5,525,671A), focused mainly on the monomer removal process of a homopolymer (as in U.S. Pat. No. 7,119,163B2), or utilized a completely different technology such as extrusion (as in U.S. Pat. No. 5,882,787A and in U.S. Pat. No. 5,656,718A).

Accordingly, the object underlying the present disclosure is to provide a process of continuously manufacturing a poly(hydroxy acid) copolymer by a ring-opening-polymerization, which requires only a comparably short reaction time even in the case that a poly(hydroxy acid) copolymer with a comparably high molecular weight and/or even when a complex branched structure shall be prepared. Moreover, the process shall allow—with the same reactor system—to easily vary the molecular weight and structure of the copolymer according to the need, in turn enabling an easy transition from the production of a certain copolymer with a certain molecular weight and structure to another copolymer of the same type, such as from a linear copolymer to a branched copolymer.

In accordance with the present disclosure, this object is satisfied by providing a process of continuously manufacturing a poly(hydroxy acid) copolymer comprising copolymerizing at least two different monomers in the presence of at least one catalyst in a reactor system by ring-opening-polymerization to form the poly(hydroxy acid) copolymer. At least one of the at least two different monomers is a cyclic ester of hydroxy acid, and a molar ratio of a total amount of the at least two different monomers to a total amount of the at least one catalyst applied during the ring-opening-polymerization is more than 10,000. The reactor system comprises in series at least two polymerization reactors, at least one of is the at least two polymerization reactors being a continuous stirred-tank reactor, a loop reactor or a plug flow reactor. At least one of the at least two polymerization reactors comprises at least one selected from the group consisting of: at least one mixer and at least one heat transfer element. The reactor system comprises in series at least two different feeding points through each of which a monomer composition is fed into the reactor system. A first monomer composition fed to the reactor system through one of the at least two feeding points is different from a second monomer composition fed into the reactor system through another one of the at least two feeding points.

This solution is based on the surprising finding that the combination of: 1) using a continuous process, 2) using a comparably high molar ratio of the total amount of the at least two different monomers to the total amount of the at least one catalyst applied during the ring-opening-polymerization of more than 10,000, 3) using a reactor system, which comprises in series at least two polymerization reactors, wherein at least one of which is a continuous stirred-tank reactor, a loop reactor or a plug flow reactor, and wherein at least one of these reactors comprises at least one mixer and/or at least one heat transfer element for homogeneously mixing and/or distributing the heat the mixture flowing through the respective reactor, and 4) using, in series, at least two different feeding points at the reactor system through each of which a monomer composition is fed into the reactor system, wherein the monomer composition being fed to the reactor system through one of the at least two feeding points is concerning its monomer(s) different from the monomer composition being fed into the reactor system through at least one other of the at least two feeding points, allows in a process of continuously manufacturing a poly(hydroxy acid) copolymer a reduction in the total residence time in the system, —based on an overall monomer conversion of at least 95% and even up to 99.5%—to as low as 2 hours, 1.5 hours, less than 1 hour or even less, even if using usual catalysts. This was unexpected, because it would have been expected that by increasing the molar ratio of the total amount of the at least two different monomers to the total amount of the at least one catalyst applied during the ring-opening-polymerization, i.e. by reducing the amount of catalyst used per mole of monomer, the residence time would increase, i.e. the time required to achieve a copolymer with a certain molecular weight at a certain conversion, or—in the best case—would leave it unchanged. More specifically, the use of one or more mixing and/or heat transfer elements allows one to assure a homogeneous mixture within the reactor system without significant heat and concentration gradients within the reactor system except the decrement of comonomer concentration throughout the reactor system due to the polymerization and the concentration increment of components after a feeding point. Thereby, an effective mixing of the reactants as well as an efficient heat removal from the highly viscous reaction mixture are assured so that the process remains—even at a comparable high reaction temperature of up to 220° C. or even above and at a low concentration of catalyst—reliably controllable and stable without undesired degradation of components of the reaction mixture or the creation of undesired by-products, such as colored by-products, within the reactor system. Moreover, the specific combination of the four aforementioned features and in particular the provision of at least two different feeding points, the specific reactor system and the continuous ring-opening-copolymerization allows, as in further detail set out below, one to easily adapt—with the same reactor system—the molecular weight and structure of the copolymer to the need. In other words, the process in accordance with the present disclosure allows production—with the same reactor system—of copolymers of different molecular weights (grades), structures and compositions, for instance by varying the temperature, the initiator contents and/or catalyst contents, and/or the number and/or location of feeding points, at which one or more monomers, catalyst and/or optional initiator are added into the reactor. Thus, with one reactor system, copolymers with different molecular weights, either linear or branched, and copolymers in the form of random or block copolymers can be produced. In particular, the process can enable an easy transition from the production of a certain copolymer with a certain molecular weight and structure, such as a linear copolymer of lactic acid and caprolactone, to another copolymer of the same type, such as to a branched copolymer of lactic acid and caprolactone. More specifically, by using more than one feeding point for feeding comonomers into the at least one continuous stirred-tank reactor, the at least one loop reactor and/or the at least one plug flow reactor, and by suitably selecting the optional initiator, the design of the polymer architecture can be tailored to the need, wherein the number of feeding points controls the randomness of the polymer chain and/or the number of blocks in the polymer chains. By tuning the residence time of the monomers, catalyst and optional initiator between the single feeding points and by appropriately adjusting the amounts of catalyst and optional initiator, the chain length of the blocks and thus the molecular weight of the copolymer can be controlled. Moreover, by adjusting the initial and intermediate feed compositions, the composition and structure of the polymer chain and the reaction rate can be controlled. Furthermore, by using an appropriate type of initiator, one can control whether the copolymer is linear or branched. On account of the aforementioned reasons, the process in accordance with the present disclosure is well suited to produce poly(hydroxy acid) copolymers, which are superior compared to linear polylactic acid, since such copolymers are usually less brittle and have a higher toughness and impact resistance than linear polylactic acid. Such copolymers, such as branched copolymers, are, if at all, only producible with prior art methods with difficulty.

Reactor system means in accordance with the present disclosure the combination of all reactors and lines connecting them with each other including the feeding points used for the process, i.e. for instance the combination of at least one continuous stirred-tank reactor and/or at least one loop reactor and/or at least one plug flow reactor, in which the process is conducted.

At least one plug flow reactor means in accordance with the present disclosure a plug flow section with one or more feeding points.

A feeding point means in accordance with the present disclosure any installation, which allows to feed a mixture comprising monomer and optionally catalyst and/or initiator and/or one or more other components into the reactor system, i.e. into one of the reactors of the reactor system or into a connection line between two of the reactors of the reactor system or into the line leading into the most downstream reactor. In particular, a feeding point is a feeding line.

Poly(hydroxy acid) copolymer means in accordance with the present disclosure any polymer, which comprises at least one cyclic ester of hydroxy acid as a first monomer and at least a second monomer that is different form the first monomer, and independently from the second monomer is also a (different) cyclic ester of hydroxy acid or another monomer being no cyclic ester of hydroxy acid. One comonomer example is polyethylene glycol. Preferably, the poly(hydroxy acid) copolymer comprises two or more different monomers, each of which is a (different) cyclic ester of hydroxy acid.

In accordance with the present disclosure, the reactor system comprises in series at least two different feeding points through each of which a monomer composition is fed into the reactor system. However, this does not exclude that the monomer composition includes, in addition to one or more monomers, further components, such as catalyst, initiator and the like. In other words, a monomer composition contains at least one monomer, but can further contain any other component. In fact, it is preferred that at least one of the monomer compositions and preferably all of the monomer compositions include catalyst, initiator and optionally further components.

In accordance with the present disclosure, the reactor system, which comprises in series at least two polymerization reactors, further comprises in series at least two different feeding points through each of which a monomer composition is fed into the reactor system, wherein the monomer composition being fed to the reactor system through one of the at least two feeding points is concerning its monomer(s) different from the monomer composition being fed into the reactor system through at least one other of the at least two feeding points.

This means in accordance with the present disclosure, that a first monomer(s) containing composition being fed into the reactor system through one of the at least two feeding points differs (regardless of whether the composition contains one or more catalysts, one or more initiators and/or one or more further non-monomer-components) concerning its contained monomer(s) from a further, second monomer(s) containing composition, which is fed into at least one other of the at least two feeding points. To differ concerning its contained monomer(s) means that i) the first composition contains a different monomer than the second composition or that ii) the first composition contains two or more different monomers with one of these being different from the monomer(s) contained in the second composition or that iii) the first and second compositions contain a mixture of two or more monomers with no difference in the chemical nature of the monomers, wherein the molar ratio of the two or more monomers of the first composition is different from the molar ratio of the two or more monomers of the second composition.

Thus, it is possible that the reactor system comprises in series two or more different feeding points through each of which a monomer composition is fed into the reactor system, wherein a first monomer composition being fed reactor system through one of the at least two feeding points contains a first monomer, and a second monomer composition being fed reactor system through another one of the at least two feeding points contains a second monomer, has a different chemical nature than the first monomer. Alternatively, the first monomer composition can comprise a first monomer and the second monomer composition can comprise a mixture of a first monomer and a second monomer having a different chemical nature than the first monomer. Still alternatively, the first monomer composition can comprise a mixture of a first monomer and a second monomer having a different chemical nature from the first monomer with a first molar ratio of the first to the second monomer, whereas the second monomer composition comprises a mixture of the same first and second monomers with a second molar ratio, wherein the first molar ratio and the second molar ratio are different from each other.

In accordance with an exemplary embodiment of the present disclosure, through at least one of the at least two feeding points a monomer composition comprising a mixture of two or more of the at least two different monomers is fed.

In accordance with another exemplary embodiment of the present disclosure, through at least two of the at least two feeding points and preferably through all of the at least two feeding points, a monomer composition comprising a mixture of two or more of the at least two different monomers is fed.

In accordance with another exemplary embodiment of the present disclosure, through one of the at least two feeding points a monomer composition comprising a mixture of two or more of the at least two different monomers with a first molar ratio of the different monomers is fed, and through another one of the at least two feeding points a monomer composition comprising a mixture of the same different monomers with a second molar ratio of the different monomers is fed, wherein the first molar ratio is different from the second molar ratio.

In accordance with an exemplary embodiment of the present disclosure, the reactor system comprises in series at least three different feeding points through each of which a monomer composition is fed into the reactor system, wherein through at least one, preferably through at least two and more preferably through at least three of the at least three feeding points a monomer composition is fed, which contains two or more of the at least two different monomers.

Preferably, in the aforementioned embodiment through one of the at least three feeding points a monomer composition comprising a mixture of two or more of the at least two different monomers with a first molar ratio of the different monomers is fed and through another one of the at least three feeding points a monomer composition comprising a mixture of the same different monomers with a second molar ratio of the different monomers is fed, wherein the first molar ratio is different from the second molar ratio.

In accordance with another variant of the aforementioned embodiment, through one of the at least three feeding points a monomer composition comprising a mixture of two or more of the at least two different monomers with a first molar ratio of the different monomers is fed, through another one of the at least three feeding points a monomer composition comprising a mixture of the same different monomers with a second molar ratio of the different monomers is fed, and through another one of the at least three feeding points a monomer composition comprising only one monomer or a mixture of the same different monomers with a third molar ratio of the different monomers is fed, wherein the first molar ratio, the second molar ratio and the third molar ratio are different from each other.

Preferably, the reactor system comprises a first feeding point upstream of the most upstream reactor and a second feeding point downstream thereof. More preferably, the second feeding point is located downstream of the most upstream reactor, but upstream of the next downstream reactor.

For instance, the reactor system comprises at least three reactors, namely at least a first, downstream thereof a second and downstream thereof a third reactor, wherein a first feeding point is located upstream of the first reactor, a second feeding point is located downstream of the first reactor, but upstream of the second reactor, and a third feeding point is located downstream of the second reactor, but upstream of the third reactor.

As set out above, the process in accordance with the present disclosure is particularly suitable to be operated so that the at least two different monomers are polymerized in the reactor system in the presence of the at least one catalyst and the optional at least one initiator by ring-opening-polymerization to form a branched poly(hydroxy acid) copolymer. Particularly, the process can be operated so that a random copolymer or a block copolymer or a combination thereof is produced. As a particular advantage, the branched poly(hydroxy acid) copolymers prepared with the method in accordance with the present disclosure can be used as foamable copolymers.

Alternatively, the process can be operated so that the at least two different monomers are polymerized in the reactor system in the presence of at least one catalyst and optional at least one initiator by ring-opening-polymerization to form a linear poly(hydroxy acid) copolymer.

In accordance with a first preferred embodiment of the present disclosure, a first part of the at least two different monomers (optionally together with catalyst and optional initiator) is added as first monomer composition to the reactor system upstream of the most upstream of the reactors, wherein the rest of the at least two different monomers is added (optionally together with catalyst and optional initiator) as a second monomer composition to the reactor system downstream thereof, i.e. into a reactor being downstream of the most upstream of the reactors, or into the most upstream reactor at a location downstream of the location, where the first part of the at least two different monomers is added, or into a connection line connecting two of the reactors. In case of a reactor system comprising i) at the upstream end one continuous stirred-tank reactor and/or one loop reactor and ii) downstream thereof at least one continuous stirred-tank reactor and/or at least one loop reactor and/or at least one plug flow reactor, the second monomer composition is added to the reactor system preferably downstream of the most upstream reactor (i) and upstream of the next downstream reactor (ii). For instance, the reactor system comprises an upstream continuous stirred-tank reactor and downstream thereof a plug flow reactor. In this case, the first monomer composition is added to the reactor system upstream of the continuous stirred-tank reactor and the second monomer composition is added to the reactor system downstream of the continuous stirred-tank reactor, but upstream of the plug flow reactor.

It is preferred in the aforementioned embodiment that the first monomer composition is a mixture of two different monomers (such as of i) lactide and ii) caprolactone or glycolide) with a first molar ratio of the two different monomers, wherein the second monomer composition is a mixture of the same two different monomers (such as of i) lactide and ii) caprolactone or glycolide) as the first monomer composition, but with a second molar ratio of the two different monomers, which is different from the first molar ratio.

In accordance with a second preferred embodiment of the present disclosure, a first part of the at least two different monomers is added as a first monomer composition to the reactor system upstream of the most upstream of the reactors, wherein a second part of the at least two different monomers is added as a second monomer composition to the reactor system into a reactor downstream of the most upstream of the reactors but upstream of the most downstream of the reactors, or into anyone of the reactors at a location downstream of the location, where the first monomer composition is added upstream of the most downstream part of the reactor system, and wherein the rest of the at least two different monomers is added as a third monomer composition to the reactor system into a reactor downstream of the reactor, into which the second monomer composition is added, or into anyone of the reactors at a location downstream of the location, where the second monomer composition is added. In case of a reactor system comprising i) at the upstream end one continuous stirred-tank reactor or one loop reactor and ii) downstream a plug flow section with two feeding points, the first monomer composition is added to the reactor system upstream of the continuous stirred-tank reactor or one loop reactor, wherein the second monomer composition is added to the reactor system downstream of the continuous stirred-tank reactor or one loop reactor but upstream of the plug flow section at the first feeding point, and the third monomer composition is added to the reactor system into the plug flow section at the second feeding point, which is located downstream of the first feeding point.

It is preferred in the aforementioned embodiment that the first monomer composition comprises a mixture of two different monomers (such as of i) lactide and ii) caprolactone or glycolide) with a first molar ratio of the two different monomers, wherein the second monomer composition comprises a mixture of the same two different monomers (such as of i) lactide and ii) caprolactone or glycolide) as the first part, but with a second molar ratio of the two different monomers, which is different from the first molar ratio, and wherein the third monomer composition comprises a mixture of the same two different monomers (such as of i) lactide and ii) caprolactone or glycolide) as the first and the second monomer compositions, but with a third molar ratio of the two different monomers, which is different from the first molar ratio and different from the second molar ratio.

Alternatively, in the second preferred embodiment, the first monomer composition can comprise a mixture of two different monomers (such as of i) lactide and ii) caprolactone or glycolide) with a first molar ratio of the two different monomers, wherein the second monomer composition comprises a mixture of the same two different monomers (such as of i) lactide and ii) caprolactone or glycolide) as the first part, but with a second molar ratio of the two different monomers, which is different from the first molar ratio, and wherein the third monomer composition comprises only one of the two different monomers (such as of lactide, caprolactone or glycolide).

As set out above, it is a particular advantage of the present disclosure that the process can easily change from the production of a certain copolymer with a certain molecular weight and structure, such as a linear copolymer of lactic acid and caprolactone or a linear copolymer of lactic acid and glycolic acid, to another copolymer of the same type, such as to a branched copolymer of i) lactic acid and ii) caprolactone or glycolic acid. This is in particular shown by the aforementioned variants, which can be easily combined together using the same reactor system. For instance, a reactor system comprising an upstream continuous stirred-tank reactor and downstream thereof a plug flow section with two feeding points can firstly be operated by only adding lactide and caprolactone (or glycolide) as monomers into a monomer composition further comprising catalyst and initiator to the reactor system at the upstream end of the continuous stirred-tank. After termination of the process, the same reactor system can easily be changed so that a first monomer composition comprising lactide, caprolactone, catalyst and initiator with a first molar ratio of lactide and caprolactone (or glycolide) is added at a first feeding point at the upstream end of the continuous stirred-tank reactor and a second monomer composition comprising lactide, caprolactone (or glycolide), catalyst and initiator with a second molar ratio of lactide and caprolactone (or glycolide) is added at a second feeding point at the upstream end of the plug flow section and that a third mixture of lactide, caprolactone (or glycolide), catalyst and initiator with a third molar ratio of lactide and caprolactone (or glycolide) is added within the plug flow section at a third feeding point being downstream of the first and second feeding points. The process can then be changed so that in a variation of the aforementioned embodiment, at the third feeding point within the plug flow section, instead of a third monomer composition comprising lactide, caprolactone (or glycolide), catalyst and initiator only a monomer composition comprising either i) lactide or ii) caprolactone (or glycolide) together with optionally catalyst and/or initiator can be added at the third feeding point within the plug flow section so as to obtain a copolymer with defined terminal blocks made of the monomer added most downstream of the reactor system.

In a further development of the idea of the present disclosure it is suggested that the process is operated so that the overall conversion of the at least two different monomers to the poly(hydroxy acid) copolymer during the ring-opening-polymerization is at least 85.0%, preferably at least 90.0%, more preferably at least 95.0%, still more preferably at least 97.0%, yet more preferably at least 99.0% and most preferably more than 99.0 to 99.5%.

The change in conversion of monomers with time can be followed according to the present disclosure by gas chromatography (GC) for instance with the following procedure. Approximately 100 mg of sample are weighed, dissolved in 10 mL of DCM containing 30 mg of 1-octanol as internal standard. 1 ml of this solution is precipitated in 10 ml of 95:5 (v/v) hexane/acetone mixture. Afterwards, 1.5 ml of the mixed suspension was filtered through a 0.45 μm polytetrafluoroethylene (PTFE) filter for measurement. For polymers produced using glycolide as one of the monomers, 100 mg of sample are weighed, dissolved in 20 ml of tetrahydrofuran (THF) containing 30 mg of 1-octanol as internal standard. 2 ml of this solution is precipitated in 10 ml of methanol. Afterwards, 1.5 ml of the mixed suspension is filtered through a 0.45 μm polytetrafluoroethylene (PTFE) filter for measurement. Measurements are performed using a GC Clarus 580 (from Perkin Elmer, UK) equipped with an auto-sampler, an injector channel, an oven and a flame ionization detector (FID). The GC column is J&W DB-17MS (Agilent). The carrier gas is Helium (99.999%, 1 ml/min of flow), while the fuel gases are purified air after filter (Drypoint M from BEKO Technologies, Germany, flow of 450 ml/min) and hydrogen (from water electrolysis, 45 ml/min flow). The injector temperature is fixed at 180° C., while the detector is set to 350° C.

Preferably, the molar ratio of the total amount of the at least two different monomers (i.e. of all of the comonomers) to the total amount of the at least one catalyst applied during the ring-opening-polymerization is at least 11,000. More preferably, the respective molar ratio is at least 12,000, yet more preferably at least 15,000, still more preferably at least 20,000, yet more preferably at least 25,000 and most preferably at least 27,000, such as about 28,000. Good results are in particular obtained, when the respective molar ratio is less than 280,000, more preferably less than 140,000 and most preferably less than 56,000.

In accordance with a further preferred embodiment of the present disclosure, at least a part of the ring-opening-polymerization is carried out at a temperature of 160° C. or more. For instance, the temperature of the ring-opening-polymerization within a part of the at least one continuous stirred-tank reactor and/or of the at least one loop reactor and/or of the at least one plug flow reactor can be 160° C. or more, whereas the temperature in another part of the at least one continuous stirred-tank reactor and/or at least one loop reactor and/or of the at least one plug flow reactor can be less than 160° C. Alternatively, the temperature of the ring-opening-polymerization within the whole of the at least one continuous stirred-tank reactor and/or at least one loop reactor and/or of the at least one plug flow reactor can be 160° C. or more. However, it is most preferred that the temperature throughout all of the reactors of the reactor system, i.e. in all of the continuous stirred-tank reactors, loop reactors, plug flow reactors and optional any further reactor, is 160° C. or more. The adjustment of this temperature range, which is slightly higher in comparison to the temperature range used in commercial production processes, allows one to enhance the reaction kinetic and thus shorten the reaction time, i.e. to decrease the residence time of the reaction mixture within the reactor system, however, surprisingly without making the process uncontrollable, which would lead to a degradation of components of the mixture within the reactor system and in particular of the produced copolymer, to the formation of colored by-products and the like. Without the intention to be bound to any theory, it is considered that this is due to the high molar ratio of monomers to the catalyst, i.e. to the comparably low concentration of catalyst in the reaction mixture. In other words, it is considered that the comparably low concentration of catalyst in the reaction mixture allows one to increase the reaction temperature at least slightly, without leading to an uncontrollable process. Good results are in particular obtained, when the ring-opening-polymerization is at least partially and more preferably completely carried out at a temperature of at least 160° C., preferably at a temperature of 160° C. to 220° C., more preferably at a temperature of 170° C. or more to 215° C., even more preferably at a temperature of 175° C. or more to 210° C., and most preferably at a temperature of 180° C. or more to 200° C.

In accordance with another preferred embodiment of the present disclosure, the content of the at least one catalyst applied during the ring-opening-polymerization is between more than 0 ppm and 200 ppm or less based on the reaction mixture. Since there are two or more feeding points for adding monomer and/or catalyst into the reaction system, the concentration of catalyst in the reaction mixture can be higher downstream of a first feeding point, wherein the maximum amount of the at least one catalyst applied during the ring-opening-polymerization in the reaction mixture in sum at any location in the reaction system is between more than 0 ppm and 200 ppm or less based on the reaction mixture. Good results are in particular obtained, when the content of the at least one catalyst applied during the ring-opening-polymerization is between 1 ppm and 180 ppm, more preferably between 10 ppm and 150 ppm, still more preferably between 20 ppm and 100 ppm and most preferably between 50 ppm and 100 ppm.

The present disclosure is not particularly limited concerning the type of monomers used. Preferably, at least one of the at least two different monomers is, or preferably all of the at least two different monomers are, a cyclic ester, which is selected from the group consisting of lactide, glycolide, caprolactone, valerolactone, decanolactone, butyrolactone, dodecalactone, octanolactone and any combination of two or more of the aforementioned compounds. More preferably at least one of the two different monomers is, or preferably all of the at least two different monomers are, a cyclic ester, which is selected from the group consisting of L-lactide, D-lactide, meso-lactide, lactide racemic mixture, glycolide, ε-caprolactone, γ-caprolactone, δ-valerolactone, γ-valerolactone, 5-decanolactone, δ-decanolactone, δ-butyrolactone, δ-dodecalactone. 5-dodecalactone, δ-octanolactone, ω-pentadecalactone and any combination of two or more of the aforementioned compounds. Examples of non-cyclic monomers are polyethylene glycol, methyl polyethylene glycol and 2-hydroxyethyl methacrylate, which can react with at least one of the above-mentioned cyclic esters, such as lactide, glycolide, caprolactone and their combination thereof.

Even more preferably, during the ring-opening-polymerization i) a lactide and a caprolactone are polymerized so as to manufacture a poly(lactide-co-caprolactone) or ii) a lactide and a glycolide are polymerized so as to manufacture a poly(lactide-co-glycolide). Still more preferably, the at least two different monomers are i) a mixture of at least one compound being selected from L-lactide, D-lactide, meso-lactide, lactide racemic mixture and any combination of two or more of the aforementioned compounds and ε-caprolactone and/or γ-caprolactone or ii) a mixture of at least one compound being selected from L-lactide, D-lactide, meso-lactide, lactide racemic mixture and any combination of two or more of the aforementioned compounds and glycolide.

In accordance with an alternative embodiment of the present disclosure, during the ring-opening-polymerization a compound being selected from L-lactide, D-lactide and meso-lactide is polymerized with another, different compound being selected from L-lactide, D-lactide and meso-lactide. For instance, L-lactide and D-lactide are polymerized so as to manufacture a poly(L-lactide-co-D-lactide) or L-lactide and meso-lactide are polymerized so as to manufacture a poly(L-lactide-co-meso-lactide).

In principle, the present disclosure is not particularly limited concerning the chemical nature of the used catalyst. In particular, good results are obtained, if the catalyst is at least one organometallic compound. Good results are in particular obtained, when the catalyst is at least one organometallic compound comprising a metal selected from the group consisting of magnesium, titanium, zinc, aluminum, indium, yttrium, tin, lead, antimony, bismuth and any combination of two or more of the aforementioned metals. The at least one organometallic compound preferably comprises as organic residue a residue selected from the group consisting of alkyl groups, aryl groups, halides, oxides, alkanoates, alkoxides and any combination of two or more of the aforementioned groups.

More preferably, the catalyst is at least one organometallic compound comprising as metal aluminum and/or tin. Still more preferably, the catalyst is at least one organometallic compound selected from the group consisting of: tin octoate, tetraphenyl tin, butyltin tri-methoxide, dibutyltin oxide, aluminum isopropoxide. Al(O-i-Pr)ₚ with 1≤p≤3, Et₃-pAl(O(CH₂)₂X)p with 1≤p≤3, α, β, γ, δ, ε, tetraphenylporphinato aluminium (TPPIAIX) and any combination of two or more of the aforementioned compounds. Particularly suitable as catalyst is tin octoate, such as tin(II) 2-ethylhexanoate.

In accordance with a further particularly preferred embodiment of the present disclosure, during the ring-opening-polymerization at least one initiator is present so that the step of polymerization includes the at least two different monomers being polymerized in the reactor system in the presence of at least one catalyst and at least one initiator.

The at least one initiator is preferably a hydroxy compound and more preferably a hydroxy compound selected from the group consisting of: monohydroxy compounds, dihydroxy compounds, trihydroxy compounds, tetrahydroxy compounds, and any combination of two or more of the aforementioned compounds. By the functionality of the at least one hydroxy compound, the design of the resulting copolymer can be adjusted. If a mono-hydroxy compound is used, a linear copolymer will be produced, whereas branched copolymers can be produced by using one or more dihydroxy compounds, trihydroxy compounds and/or tetrahydroxy compounds.

Good results are in particular obtained, when the at least one initiator is selected from the group consisting of 2-ethyl hexanol, 1-decanol, C₁₀-C₂₀-monohydroxy fatty alcohols, benzyl alcohol, p-phenylbenzyl alcohol, ethylene glycol, propylene glycol, butane-1,4-diol, poly(ethylene glycol) with a weight average molecular weight of 200 to 10,000 g/mol, 2-hydroxymethyl-1,3-propane, glycerol, polyglycerol with a weight average molecular weight of 100 to 1,000 g/mol, trihydroxybenzene (phloroglucinol), trimethylolpropane and its dimer, pentaerythritol and its dimers and any combination of two or more of the aforementioned compounds.

In a further development of the idea of the present disclosure, it is suggested that the molar ratio of the total amount of the at least two different monomers to the total amount of the at least one initiator applied during the ring-opening-polymerization is 100 to 10,000. More preferably, the molar ratio of the total amount of the at least two different monomers to the total amount of the at least one initiator applied during the ring-opening-polymerization is 300 to 10.000, even more preferably 500 to 10.000 and most preferably 500 to 3,000.

The total amount of the at least one initiator applied during the ring-opening-polymerization can be also expressed as less than 0.1 to 50 meq or less than 0.1 to 50 mmol/kg, respectively, preferably 0.5 to 40 meq or mmol/kg, respectively, more preferably 1 to 30 meq or mmol/kg, respectively, and most preferably 10 to 20 meq or mmol/kg, respectively.

In accordance with the present disclosure, the reactor system, which comprises in series at least two polymerization reactors, can comprise any possible combination of at least one continuous stirred-tank reactor and/or at least one loop reactor and/or at least one plug flow reactor. Preferably, the reactor system comprises, in series i) at the upstream end one continuous stirred-tank reactor or one loop reactor and ii) downstream thereof at least one continuous stirred-tank reactor and/or at least one loop reactor and/or at least one plug flow reactor. For instance, the reactor system comprises, in series seen from upstream to downstream i) three continuous stirred-tank reactors, ii) three loop reactors, iii) a continuous stirred-tank reactor and a plug flow section preferably with two feeding points or iv) a loop reactor and a plug flow section preferably with two feeding points. Between any of two adjacent of the aforementioned reactors, a pump can be provided.

In accordance with a further particularly preferred embodiment of the present disclosure, the reactor system comprises i) at the upstream end one or more continuous stirred-tank reactors and ii) downstream thereof at least one plug flow reactor. Alternatively, the reactor system can comprise i) at the upstream end one or more loop reactors and ii) downstream thereof at least one plug flow reactor. Still alternatively, the reactor system can comprise i) at the upstream end one continuous stirred-tank reactor or one loop reactor and ii) downstream thereof one or more continuous stirred-tank reactors and/or one or more loop reactors and iii) downstream thereof a plug flow reactor. This allows one to efficiently locate the multiple feeding points within the reactor system allowing to produce the copolymers with a specified design, composition and molecular weight. Furthermore, it allows one to easily change one or more feeding points in the reaction plant so that the process is easily modified from the production of a certain copolymer with a certain molecular weight and structure, such as a linear copolymer of lactic acid and caprolactone, to another copolymer of the same type, such as to a branched copolymer of lactic acid and caprolactone. Between any of two adjacent of the aforementioned reactors, a pump can be provided.

Preferably, the reactor system comprises one or two continuous stirred-tank reactors and downstream thereof a plug flow reactor section, wherein the reactor system comprises two or more feeding points. Alternatively, the reactor system preferably comprises one or two loop reactors and downstream thereof a plug flow reactor section, wherein the reactor system comprises two or more feeding points. For example, the reactor system comprises one loop reactor and downstream thereof a plug flow reactor section, wherein the reactor system comprises two feeding points. For instance, the reactor system comprises one continuous stirred-tank reactor and downstream thereof a plug flow reactor section, wherein the reactor system comprises two feeding points. Between any of two adjacent of the aforementioned reactors, a pump can be provided.

In accordance with the present disclosure, the reactor system comprises at least one mixer and/or at least one heat transfer element, i.e. preferably at least one of the at least one continuous stirred-tank reactor, at least one loop reactor or at least one plug flow reactor of the reactor system comprises at least one mixer and/or at least one heat transfer element. The mixer can be a static mixer, a dynamic mixer or a combination of both.

Preferably at least 50%, more preferably at least 75% and most preferably all of the reactors of the reactor system comprise at least one mixer and/or at least one heat transfer element and more preferably at least one mixer as well as at least one heat transfer element. More preferably, any of the continuous stirred-tank reactors, if present, comprises a dynamic mixer and preferably also a heat transfer element, wherein any of the loop reactors, if present, and any of the plug flow reactors, if present, comprises at least one static mixer, and more preferably also at least one heat transfer element. The mixer(s) and heat transfer element(s) can be combined, namely so that the static mixer is made of hollow pipes, which are formed so that the reaction mixture is mixed, when it passes through the area formed between the hollow pipes. By pumping heat transfer medium through the hollow pipes, they also function as heat transfer elements. Thus, it is particularly preferred that the reactor system comprises, in series i) at the upstream end one continuous stirred-tank reactor comprising at least one dynamic mixer and/or a heat transfer element or one loop reactor comprising at least one static mixer and/or a heat transfer element and ii) downstream thereof at least one continuous stirred-tank reactor comprising at least one dynamic mixer and/or a heat transfer element and/or at least one loop reactor comprising at least one static mixer and/or a heat transfer element and/or at least one plug flow reactor comprising at least one static mixer and/or a heat transfer element. Most preferably, the reactor system comprises, in series seen from upstream to downstream i) three continuous stirred-tank reactors each comprising at least one dynamic mixer and optionally also a heat transfer element, ii) three loop reactors each comprising at least one static mixer and optionally also a heat transfer element, iii) a continuous stirred-tank reactor comprising at least one dynamic mixer and optionally also a heat transfer element and a plug flow section preferably with two feeding points comprising at least one static mixer and optionally also a heat transfer element or iv) a loop reactor and a plug flow section preferably with two feeding points each comprising at least one static mixer and optionally also a heat transfer element. Between any of two adjacent of the aforementioned reactors, a pump can be provided.

As set out above, the mixer used in a continuous stirred-tank reactor is preferably a dynamic mixer, i.e. a mixer comprising moving and in particular rotating parts. The dynamic mixer can be a dynamic mixer of the impeller-type, such as preferably a dynamic mixer comprising one or more paddle-type impellers, one or more anchor type-impellers, one or more gate-type impellers and/or one or more helical-type impellers.

As further set out above, the mixer used in a loop reactor or in a plug flow reactor is preferably a static mixer. i.e. a mixer not comprising moving and in particular rotating parts. Static mixers usually produce a mixing effect by generating a turbulent flow due to static, i.e. non-moving elements, such as plates, bars, crossbars, baffles, helically formed deflection means, grids and the like. Suitable examples for static mixers, are x-type static mixers, spiral/helical-type static mixers, quattro-type static mixers, baffle plate-type static mixers, turbulator strips-type static mixers and any combination of two or more of the above-mentioned mixer types. X-type static mixers comprise deflection means in the form of bars, crossbars, plates or the like having in a plan view and/or side view and/or cross-sectional view a x-like form. Such x-type static mixers are described for instance in WO 2010/066457 A1, EP 1 206 962 A1, EP 2 158 027 B1 and EP 0 655 275 B1 and are commercially available from Sulzer Chemtech Ltd, Winterthur, Switzerland under the tradenames SMX, SMXL and SMX plus as well as from Fluitec, Neftenbach, Switzerland under the tradename CSE-X. Spiral/helical-type static mixers have a helically formed deflection means and are described for instance in U.S. Pat. No. 3,743,250 A, whereas quattro-type static mixers comprise deflection means forming chamber-like mixing sections and are described for instance in EP 2 548 634 B1 and in EP 0 815 929 B1. While baffle plate-type static mixers comprise usually longitudinal deflection means and are described for instance in EP 1 510 247 B1 and in U.S. Pat. No. 4,093,188 A, turbulator strip-type static mixers comprise in a tube a plurality of elongated strips, each of which being formed by a series of alternating deflection panels successively joined together by for example substantially triangular bridging portions with the strips being held together and anchored substantially on the axis of the tube by alternate ones of the bridging portions and the other bridging sections being disposed adjacent the inner wall of the tube and are described for instance in U.S. Pat. No. 4,296,779 A. Other suitable static mixers are distributed from Sulzer Chemtech AG under the tradenames CompaX, SMI, KVM, SMV and GVM and from Stamixco AG, Wollerau, Switzerland under the tradename GVM.

In a further development of the idea of the present disclosure it is suggested to use as heat transfer element a tube bundle heat exchanger. Preferably, the tube bundles of the heat transfer element are formed so that they simultaneously function as static mixing element. Such heat transfer elements, which are also static mixers, are for instance described in EP 1 967 806 B1 and in EP 2 052 199 B1 and are commercially available form Sulzer Chemtech AG under the tradename SMR and from Fluitec under the tradename CSE-XR. For example, such a combined heat transfer element and static mixer comprises a housing disposed on a longitudinal axis and a plurality of installations in the housing, each the installation including at least a first hollow structure and at least a second hollow structure for the passage of a first fluid therethrough and the passage of a second fluid thereover, the first hollow structure and the second hollow structure being arranged cross-wise with respect to one another, each the hollow structure having a flow cross-section with a first width B1 and a second width B2 perpendicular to the first width B1, with the ratio B1/B2 being larger than one and B1 being oriented normally to a plane contains the longitudinal axis of the housing. Moreover, such a combined heat transfer element and static mixer can comprise fittings arranged in a casing of extending longitudinally between a head end and a base end so that the fittings form a heat-transferring and mixing structure, whereby the fittings comprise tubes so that the heat-transferring medium is transportable as inner stream inside the tubes of the fittings from the base end to the head end and the liquid is transportable as outer stream outside the tubes from the head end to the base end, whereby the tubes of the fittings preferably form plane layers arranged in parallel, in which one respective tube extend from one entry end to an outlet end in a serpentine configuration comprising arcs and parallel partial tubular pieces. Reinforcement elements can be provided, which stabilize the tubes of the fittings in longitudinal direction against the pressure gradients generated by the liquid, whereby the reinforcement elements connect the parallel partial tubular pieces in a main area to form a non-extensible partial structure, and whereby the fittings remain partially unreinforced in an auxiliary area as a longitudinally extensible partial structure that complements the main area.

In a further development of the idea of the present disclosure, it is proposed that the residence time—or reaction time, respectively—in the reactor system is adjusted to be 0.1 to 5.0 hours, more preferably 0.2 to 4.0 hours, yet more preferably 0.3 to 3.0 hours, still more preferably 0.4 to 2.0 hours, yet more preferably 0.4 to 1.5 hours and most preferably 0.4 to less than 1 hour. The residence time—or reaction time, respectively—can be adjusted, among others, by appropriately selecting the volume of the continuous stirred-tank reactors, the length of the loop reactors and the plug flow reactors and the flow rate of the components of the reaction mixture. Alternatively, for reactions requiring a very short residence time in the reactor system, the option to bypass one of the sections of the plug flow reactors can be used to enable a flexible operation with the same reactor system. In contrast, for reactions requiring a very long residence time in the reactor system, the processing fluid from one of the plug flow reactors can be recycled back to the aforementioned continuous stirred-tank reactor or loop reactor. These options can be realized by having valves before each reactor section to direct the fluid flow.

Preferably, the poly(hydroxy acid) copolymer produced during the ring-opening-polymerization has a weight average molecular weight of at least 10,000 g/mol, preferably of at least 20.000 g/mol, more preferably of at least 40,000 g/mol and yet more preferably at least 60,000 g/mol. The upper limit for the weight average molecular weight of the poly(hydroxy acid) copolymer produced during the ring-opening-polymerization is preferably 200,000 g/mol, but can be also 180,000 g/mol, 150,000 g/mol or 150,000 g/mol.

According to another embodiment of the present disclosure, it is preferred that the poly(hydroxy acid) copolymer produced during the ring-opening-polymerization has a number average molecular weight of at least 5,000 g/mol, preferably of at least 15,000 g/mol, more preferably of at least 25,000 g/mol, yet more preferably at least 35,000 g/mol and most preferably at least 45,000 g/mol. The upper limit for the number average molecular weight of the poly(hydroxy acid) copolymer produced during the ring-opening-polymerization is preferably 110,000 g/mol, but can be also 90,000 g/mol or 80,000 g/mol. Suitable ranges for the number average molecular weight of the poly(hydroxy acid) copolymer produced during the ring-opening-polymerization can be for instance 10,000 to 20,000 g/mol, 20.000 to 30,000 g/mol, 30.000 to 50,000 g/mol or 50,000 to 80,000 g/mol.

In accordance with the present disclosure, the number- and weight-average molecular weight (Mn and Mw) of polymers is determined by gel permeation chromatography using a poly(methyl methacrylate) standard and a sample concentration of 1 to 5 mg/ml in 1 ml HFIP depending on the sample's molecular weight, wherein the column temperature is 40° C., the temperature of the RI-Detector (refractive index) is 40° C. and the flow rate 1 ml/min. As an instrument, (GPC Viscotek TDA max from Malvern Panalytical. UK equipped with a Viscotek VE 2001 solvent/sample module, a precolumn HFIP guard (50 mm length and 8 mm internal diameter), two columns (Viscotek HFIP6000M and HFIP3000, Viscotek. Switzerland; 300 mm length and 8 mm internal diameter), and a triple detector Viscotek TDA 305 (RI, UV and viscosimeter) can be used. The calibration curve can be constructed using poly(methylmethacrylate) (PMMA) standard (Mn,max=50,352 g/mol and D of 1.023).

The polydispersity index, i.e. the ratio of Mw/Mn, of the poly(hydroxy acid) copolymer produced during the ring-opening-polymerization can be preferably 1 to 3, more preferably 1 to 2, and most preferably 1 to 1.5.

In a further development of the idea of the present disclosure, it is suggested that the poly(hydroxy acid) copolymer produced during the ring-opening-polymerization has a yellowness index below 40, preferably below 30, more preferably below 15, even preferably below 10, yet more preferably below 5 and most preferably less than 3. The yellowness index is measured in accordance with the present disclosure in accordance with ASTM E313.

It is preferred that after the polymerization ring-opening-polymerization, the non-reacted monomers remaining in the polymerization product are removed to a final concentration of preferably less than at least 0.5% by weight, in order to obtain a product of marketable quality. Such a removal of unreacted monomer, such as lactide, can be achieved by means of at least one devolatilization step conducted at elevated temperature e.g. between 190 and 230° C. and at a reduced pressure of e.g. below 5 mbar(absolute). For example, a two-stage devolatilization process can be performed in order to obtain the required degree of monomer and particularly lactide removal and thus to obtain a polymer having the required quality. In order to stop the polymerization reaction, an inhibitor is preferably added to the polymer product at the end of the polymerization and before or after the first devolatilization step. In order to maximize the yield of polymer product per amount of monomer feed, such as lactide feed, it is further preferred that the unreacted monomer, such as lactide is recovered after the devolatilization e.g. by condensation, then optionally the condensed product is purified and thereafter the condensed product is recycled into the polymerization reaction. In particular, the addition of one or more efficient inhibitor additives at the end of the polymerization reaction is preferred for an efficient devolatilization. Before the first devolatilization step, between the first and second devolatilization step or after the second devolatilization step additives and/or other polymers can be mixed and/or blended in one or more units for mixing and/or blending additives into the product stream in order to improve the mechanical, rheological and/or thermal properties of the final polymer product.

Moreover, the final polymer product stream can be cooled in a cooler and then pressed through a granulator or pelletizer, respectively, or through another forming unit.

### BRIEF DESCRIPTION OF THE DRAWINGS

The disclosure will be explained in more detail hereinafter with reference to the drawings,

FIGS. 1A to IF illustrate six specific reactor systems suitable for performing the method in accordance with an embodiment of the present disclosure.

FIG. 2 illustrates general possible reactor combinations for suitable reactor systems being suitable for performing the method in accordance with an embodiment of the present disclosure.

FIGS. 3A to 3D illustrate four different types of dynamic mixers useable in the method in accordance with an embodiment of the present disclosure.

FIGS. 4A to 4E illustrate four different types of static mixers one of which being also a heat transfer element useable in the method in accordance with the an embodiment of the present disclosure.

### DETAILED DESCRIPTION

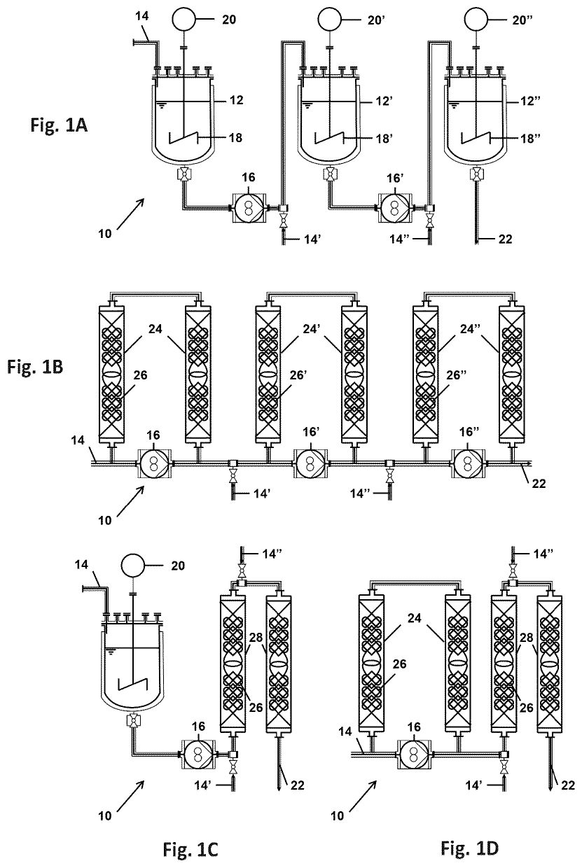

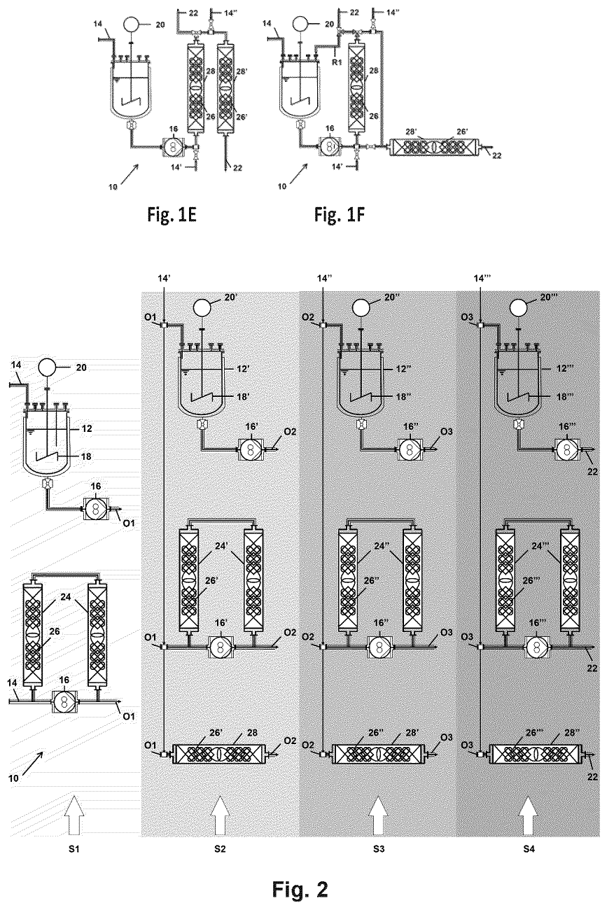

FIG. 1A shows a reactor system 10 suitable for performing the method in accordance with the present disclosure according to a first embodiment, which comprises in series three continuous stirred-tank reactors 12, 12′, 12″. Three feeding points 14, 14′, 14″ for adding monomer, catalyst and initiator are provided upstream of the most upstream continuous stirred-tank reactors 12, between the first and second continuous stirred-tank reactors 12, 12′ and between the second and most downstream continuous stirred-tank reactors 12′, 12″. Between each two of the continuous stirred-tank reactors 12, 12′ and 12′. 12″ a pump 16, 16′ is provided. Each of the continuous stirred-tank reactors 12, 12′, 12″ comprises an agitated, i.e. dynamic mixer 18, 18′, 18″, each of which is driven by a motor 20, 20′, 20″. The product stream is withdrawn from the most downstream continuous stirred-tank reactors 12″ via line 22.

FIG. 1B shows a reactor system 10 being similar to that of FIG. 1A, except that the continuous stirred-tank reactors 12, 12′, 12″ are replaced by three loop reactors 24, 24′, 24″, each of which comprising two static mixers embodied also as heat transfer element 26, 26′, 26″ and each of which comprising a pump 16, 16′, 16″.

FIG. 1C shows a reactor system 10 comprising a continuous stirred-tank reactor 12 and downstream thereof two plug flow reactors 28, 28′, each of which comprising two static mixers embodied also as heat transfer element 26, whereas FIG. 1D shows a reactor system 10 comprising a loop reactor 24 and downstream thereof two plug flow reactors 28 and 28′, each of which comprising two static mixers embodied also as heat transfer element 26′, 26″.

FIG. 1E shows a reactor system 10 being similar to that of FIG. 1C, except that an additional valve is located after the first plug flow reactor 28 to enable the bypassing of the second plug flow reactor 28′.

FIG. 1F shows a reactor system 10 being similar to that of FIG. 1E, except that an additionally valve is located between the outlet of the first plug flow reactor 28 and the continuous stirred tank reactor 12 to enable a recycling R1 and that an additional valve is located between the pump 16 and the second plug flow reactor 28′ to guide the flow direction.

FIG. 2 shows general possible reactor combinations for reactor systems being suitable for performing the method in accordance with the present disclosure. From left to right, four segments S1, S2, S3, S4 are shown, wherein the left segment S1 shows (from top to bottom) two alternative reactors and any of segments 2 to 4 show (from top to bottom) three alternative reactors. Any or the reactors shown in segment S1 can be used as most upstream reactor of the reactor system 10, i.e. either the continuous stirred-tank reactor 12 or the loop reactor 24. The most upstream reactor 12, 24 is connected via its outlet O1 with any one of the reactors shown in segment S2, i.e. either with the continuous stirred-tank reactor 12′, with the loop reactor 24′ or with the plug flow reactor 28. In turn, the reactor of segment S2 is connected via its outlet O2 with any one of the reactors shown in segment S3, i.e. either with the continuous stirred-tank reactor 12″, with the loop reactor 24″ or with the plug flow reactor 28′. Finally, the reactor of segment S3 is connected via its outlet O3 with any one of the reactors shown in segment S4, i.e. either with the continuous stirred-tank reactor 12″′, with the loop reactor 24″′ or with the plug flow reactor 28″. Between any of segments S2 and S3 as well as S3 and S4 one or more other reactors selected from the group consisting of continuous stirred-tank reactors, of loop reactors and of plug flow reactors can be added. At the outlet of segments S2, S3, a valve is added to enable the continuous passage to the next segment, i.e., O2, O3, or a bypass as final outlet 22.

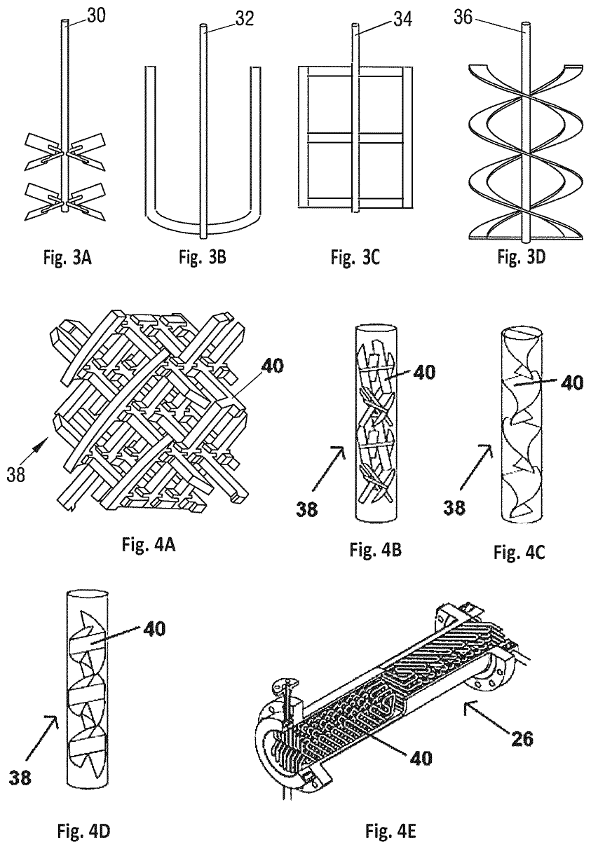

FIG. 3 shows four different types of dynamic mixers useable in the method in accordance with the present disclosure, namely in FIG. 3A a dynamic mixer with a paddle-type impeller 30, in FIG. 3B a dynamic mixer with an anchor-type impeller 32, in FIG. 3C a dynamic mixer with a gate-type impeller 34, and in FIG. 3D a dynamic mixer with a helical-type impeller 36.

FIG. 4 shows five different types of static mixers useable in the method in accordance with the present disclosure, namely in FIG. 4A a static mixer 38 of the x-type comprising deflection means 40 in the form of crossbars having in a plan view as well as in side view a x-like form. FIG. 4B shows a static mixer 38 of the baffle plate-type comprising longitudinal deflection means 40, whereas FIGS. 4C and 4D show static mixers 38 with curved deflection means 40. FIG. 4E shows a combined static mixer and heat transfer element 26 with tube-like deflection means 40 being formed so that they function as heat transfer element by transporting heat transfer medium within the tubes and simultaneously as static mixer for liquid being transported outside of the tube-like deflection means 40, such as it is commercially distributed by Sulzer Chemtech Ltd under the tradename SMR.

Subsequently, the present disclosure is described by means of illustrative, but not limiting examples.

### Example 1

### (Continuous Melt Polymerization to Produce PLA-co-PCL Copolymers in Block or Random Form Through Multiple (2 or 3) Monomer(*) Dosing)

This example has been performed with a 2 to 4 kg/h melt polymerization reactor system, which comprised at the upstream end a continuous stirred-tank reactor and at the downstream end a double-jacketed plug flow reactor encompassing static mixer internals.

To produce a block copolymer of poly(lactide-co-caprolactone) (PLA-co-PCL) with an overall composition of L-lactide/caprolactone (LT/CL) of 8/2 (w/w), L-lactide and ε-caprolactone were separately loaded into two melt tanks and be molten/heated under nitrogen atmosphere at 120° C. L-lactide was pumped at a throughput of 2.4 kg/h into the 2.0 L continuous stirred-tank reactor, which was heated by an oil heat transfer unit operated at 185° C. (reaction medium at 180° C.). Separately from this feed, tin octoate/toluene (40 mg/ml) catalyst and 2-ethyl hexanol were introduced to maintain the total molar monomer/catalyst ratio within the range of 18,700 and 56,000 and the initiator amount at 20 meq OH, respectively. With a residence time of 20 to 60 min in the continuous stirred-tank reactor, the polymer was withdrawn from the reactor, mixed with another stream of 0.6 kg/h pure C-caprolactone, and fed to the double-jacketed static mixer-based plug flow reactor operated at the same temperature. With a total residence time within 30 to 90 min, the final product was mixed with 0.1 wt. % Adeka Stab AX-71 in a short static mixer and be passed through the devolatilization unit, pelletizer, crystallizer and dryer. The number average molecular weight of the copolymer was at least 30 kg/mol and reached 75 kg/mol at lower initiator content. The nature of a block PLA-co-PCL copolymer was revealed through differential scanning calorimetry (DSC), where two individual glass transition temperature peaks (when amorphous) and/or (at least) one melting temperature peak were observed. Compared to a single-feeding point system, which would lead to a combination of random and block copolymers in a polymer chain, the crystallization process of both PLA and PCL blocks is highly favorable. Within a stable range of temperature, the polymer shows elastic character, but a typical single-phase polymeric behavior at higher temperature. Accordingly, this block copolymer system demonstrates a shape-memory property, which makes it suitable for specialized applications.

A similar block copolymer of PLA-co-PCL was prepared by reversing the sequence of dosing of lactide (second step) and ε-caprolactone (first step).

A “close to” random PLA-co-PCL copolymer was prepared through a copolymerization system comprising two monomers feeding points. Random PLA-co-PCL copolymer with the same overall composition of LT/CL of 8/2 (w/w) was produced by first introducing 1.56 kg/h of L-lactide and 0.74 kg/h of ε-caprolactone into the 2.0 L continuous stirred-tank reactor, which was heated by an oil heat transfer unit operated at 185° C. (reaction medium at 180° C.). Separately from this feed, tin octoate/toluene (40 mg/ml) catalyst and 2-ethyl hexanol were introduced to maintain the total molar monomer, catalyst ratio within the range of 18,700 and 56,000 and the initiator amount at 20 meq OH, respectively. With a residence time of 30 to 60 min in the continuous stirred-tank reactor, the polymer and residual monomers were withdrawn from the reactor, mixed with another stream of 0.7 kg/h pure L-lactide, and fed to the double-jacketed static mixer-based plug flow reactor operated at the same temperature. With a total residence time within 40 to 120 min, the final product was mixed with 0.1 wt. % Adeka Stab AX-71 in a short static mixer and be passed through the devolatilization unit, pelletizer, crystallizer and dryer. A number average molecular weight analogues to the block copolymer was obtained. The nature of random PLA-co-PCL copolymer was revealed through DSC, where one glass transition temperature peak and one or none melting temperature peak were observed. The random nature of the polymer chains has greatly hindered the crystallization of polymer, leading to an amorphous polymer. On the other hand, the introduced degree of randomness increases the degradation rate, favoring its biodegradable/compostable applications.

A closer to random copolymer was obtained using three feeding points. The first feed composition and flow rate as well as that of catalyst and initiator were kept constant. Then, the second feed of the lactide was split into two exact portions: one at the upstream of the downstream plug flow reactor and one at the intermediate position of the plug flow reactor. Overall residence time was within the proposed time frame of 40 to 120 min. The posttreatment processes remained the same.

An even closer to ideally random copolymer was obtained using as simple as two feeding points and each of a different mixture of two monomers. 1.30 kg/h of L-lactide and 0.61 kg/h of ε-caprolactone were introduced into the 2.0 L continuous stirred-tank reactor, which was heated by an oil heat transfer unit operated at 185° C. (reaction medium at 180° C.). Separately from this feed, tin octoate/toluene (40 mg/ml) catalyst and 2-ethyl hexanol were introduced to maintain the total molar monomer/catalyst ratio within the range of 18,700 and 56,000 and the initiator amount at 20 meq OH, respectively. With a residence time of 30 to 60 min in the continuous stirred-tank reactor, the polymer and residual monomers were withdrawn from the reactor, mixed with another stream of mixture of 0.92 kg/h L-lactide and 0.16 kg/h of ε-caprolactone, and fed to the double-jacketed static mixer-based plug flow reactor operated at the same temperature. With a total residence time within 60 to 150 min, the reaction was terminated using the same inhibitor, devolatilized, pelletized, crystallized and dried. As a trade-off to abovementioned process, the residence time is prolonged and a large recycle stream of residual monomers are required.

### Example 2

### (Continuous Melt Polymerization to Produce PLA-co-PGA Copolymers in Block OR Random Form Through Multiple (2 or 3) Monomer(s) Dosing)

The same 2 to 4 kg/h melt polymerization reactor system as used in example 1 was applied to produce the block or random copolymer of poly(lactide-co-glycolide) (PLA-co-PGA).

To produce a block copolymer of PLA-co-PGA with an overall composition of LTG, of 9/1 (w/w), L-lactide and glycolide were separately loaded into two melt tanks and be molten under nitrogen atmosphere at 120° C. L-lactide was pumped at a throughput of 2.7 kg/h into the 2.0 L continuous stirred-tank reactor, which was heated by an oil heat transfer unit operated at 185° C. (reaction medium at 180° C.). Separately from this feed, tin octoate/toluene (40 mg/ml) catalyst and dodecanol were introduced to maintain the total molar monomer/catalyst ratio within the range of 18,700 and 56.000 and the initiator amount at 20 meq OH, respectively. With a residence time of 20 to 60 min in the continuous stirred-tank reactor, the polymer and residual monomers were withdrawn from the reactor, mixed with another stream of 0.3 kg/h pure glycolide, and fed to the double-jacketed static mixer-based plug flow reactor operated at an elevated temperature of 200° C. With a total residence time within 30 to 90 min, the final product was mixed with 0.1 wt. % Adeka Stab AX-71 in a short static mixer and be passed through the devolatilization unit, pelletizer, crystallizer and dryer. The number average molecular weight was at least 25 kg/mol and reached up to 75 kg/mol by lowering the initiator content. The nature of a block PLA-co-PGA copolymer was revealed through DSC, where up to two individual glass transition temperatures (when amorphous) and/or (at least) one melting temperature were observed. The controlled design of PLA-co-PGA block copolymer enhances the tensile strength when comparing to the PLGA random copolymer mentioned below.

A similar block copolymer of PGA-co-PLA was produced by reversing the sequence of dosing of lactide (second step) and glycolide (first step). Given the higher melting temperature of PGA, the reaction in the first and second segments was kept at 220 and 200° C., respectively.

A “close to” random PLGA copolymer was prepared through the same copolymerization system comprising three monomers feeding points. Random PLGA copolymer with the same overall composition of LT/GL of 9/1 (w/w) was produced by first introducing 2.72 kg/h of L-lactide and 0.22 kg/h of glycolide into the 2.0 L continuous stirred-tank reactor, which was heated by an oil heat transfer unit operated at 195° C. (reaction medium at 190° C.). Separately from this feed, tin octoate/toluene (40 mg/ml) catalyst and dodecanol were introduced to maintain the total molar monomer/catalyst ratio within the range of 18,700 and 56,000 and the initiator amount at 20 meq OH, respectively. With a residence time of 20 to 60 min in the continuous stirred-tank reactor, the polymer and residual monomers were withdrawn from the reactor, mixed with another stream of 0.056 kg/h pure glycolide, and fed to the double-jacketed static mixer-based plug flow reactor operated at the same temperature. After half of the residence time of the entire plug flow reactor segment, 0.017 kg/h pure glycolide can be fed as the third feed to maximize the consumption of residual L-lactide. With a total residence time within 30 to 90 min, the final product was mixed with 0.1 wt. % Adeka Stab AX71 in a short static mixer and be passed through the devolatilization unit, pelletizer, crystallizer and dryer. The number average molecular weight analogues to the block copolymer was obtained. The nature of random PLGA copolymer was revealed through DSC, where one glass transition temperature peak and one melting temperature peak were observed. The random nature of the polymer chains hindered the polymer crystallization process. Compared to the PLA-co-PCL copolymer system in example 1, random PLGA exhibited a stronger hydrolytic behavior, which is revealed by the short biodegradation time (ca. 5-6 months).

### Example 3

### (Continuous Melt Polymerization to Produce Copolymers of PLA. PEG and PCL in Block or Random Form Through Multiple Monomer(s) Dosing)

Penta-block copolymers of PCL-PLA-PEG-PLA-PCL with an overall composition of LT/CL of 8/2 (w/w) was produced using the same 2-4 kg/h melt polymerization reactor system. L-lactide and C-caprolactone were separately loaded into two melt tanks and be molten/heated under nitrogen atmosphere at 120° C. L-lactide was pumped at a throughput of 2.4 kg/h into the 2.0 L continuous stirred-tank reactor, which was heated by an oil heat transfer unit operated at 185° C. (reaction medium at 180° C.). Separately from this feed, tin octoate/toluene (40 mg/ml) catalyst and molten polyethylene glycol (PEG) of a molecular weight of 2000 g/mol were introduced to maintain the total molar monomer/catalyst ratio within the range of 18.700 and 56,000 and a PEG amount of 20 meq OH (2 wt %), respectively. With a residence time of 20 to 60 min in the continuous stirred-tank reactor, the polymer was withdrawn from the reactor, mixed with another stream of 0.6 kg/h pure ε-caprolactone, and fed to the double-jacketed static mixer-based plug flow reactor operated at the same temperature. With a total residence time within 30 to 120 min, the final product was mixed with 0.1 wt. % Adeka Stab AX-71 in a short static mixer and be passed through the devolatilization unit, pelletizer, crystallizer and dryer. The number average molecular weight of the copolymer was at least 30 kg/mol and reached 90 kg/mol at lower PEG content. The presence of a long aliphatic ethylene glycol core improves the elasticity of the polymer.

A reversed penta-block copolymer of PLA-PCL-PEG-PCL-PLA was prepared by reversing the sequence of dosing of lactide (second step) and ε-caprolactone (first step). With the dominant fraction of PLA as “caps” of the polymer chains, the crystallinity is higher than that of the PCL-PLA-PEG-PLA-PCL block copolymer and thus enables a different application.

The same approach can be applied to produce other penta-block copolymers comprising PLA, PGA, PEG, PCL and/or polymer derived from other ring-type monomers such as δ-valerolactone, δ-decalactone and ε-decalactone, which have similar reactivity ratio as ε-caprolactone. The most relevant examples other than the penta-block system of PLA, PEG and PCL was the combination of PGA, PEG and PCL, where PCL or PGA could be as endcapping polymers. Another proven successful penta-block copolymer system is based on PEG, L-lactide and ε-decalactone. This copolymer with the PEG and then ε-decalactone as a central block exhibits outstandingly tough material characteristics and high elongation at break.

Focusing on the system of PLA, PEG and PCL copolymers, this disclosure enables a simple switch to the production of a PEG-core, random PLA-co-PCL tri-block copolymer using the same approach as example 1. In this case, the copolymer is the least crystalline and the most elastic compared to abovementioned penta-block copolymers. The reaction time of this continuous process was shortened in view of the higher reactivity of PEG compared to mono-hydroxy alcohols. Yet, the application of such tri-block copolymer is less relevant.

### Example 4

### (Continuous Melt Polymerization to Produce Star-Shape PLA-Co-PCL Copolymer in Block OR Random Form Through Multiple Monomer(s) Dosing)

Star-shape PLA-co-PCL block copolymers with the same overall composition of LT/CL of 8/2 (w/w) was produced using the same 2 to 4 kg/h melt polymerization reactor system. L-lactide and ε-caprolactone were separately loaded into two melt tanks and be molten/heated under nitrogen atmosphere at 120° C. Star-shape initiator, pentaerythritol, is first suspended and well-mixed in the L-lactide melt to fix the initiator content at 20 meq OH. Then, the mixture was pumped at a throughput of 2.4 kg/h into the 2.0 L continuous stirred-tank reactor, which was heated by an oil heat transfer unit operated at 185° C. (reaction medium at 180° C.). Separately from this feed, tin octoate/toluene (40 mg/ml) catalyst was introduced to maintain the total molar monomer/catalyst ratio within the range of 18,700 and 56,000. With a residence time of 15 to 40 min in the continuous stirred-tank reactor, the polymer and residual monomers were withdrawn from the reactor, mixed with another stream of 0.6 kg/h pure ε-caprolactone, and fed to the double-jacketed static mixer-based plug flow reactor operated at the same temperature. With a total residence time within 30 to 90 min, the final product was mixed with 0.1 wt. % Adeka Stab AX-71 in a short static mixer and be passed through the devolatilization unit, pelletizer, crystallizer and dryer. The number average molecular weight of the copolymer was at least 50 kg/mol and reached 160 kg/mol at lower pentaerythritol content. The nature of this star-shape block star-(PLA-PCL)₄ copolymer was revealed through DSC. In view of the unique star-shape as well as the outstanding molecular weight, the impact resistance and melt strength of this copolymer are greatly enhanced. Despite the irregularity of the star-shape that hinders the crystallization, a semi-crystalline polymer can be obtained.

A reversed star-shape block star-(PCL-PLA)₄ was prepared by reversing the sequence of dosing of lactide (second step) and ε-caprolactone (first step). Instead of loading the pentaerythritol in the lactide melt tank, this initiator was mixed with the ε-caprolactone and fed in the first step. Similar to example 3, the dominant fraction of PLA as “caps” of the polymer chains of this star-(PCL-PLA)₄ facilitated the crystallization, giving a stiffer polymer.

A “close to” random star-shape PLA-co-PCL copolymer with the same overall composition of LT/CL of 8/2 (w/w) was produced by first introducing 1.56 kg/h of the pentaerythritol-containing L-lactide (20 meq OH pentaerythritol in L-lactide) and 0.74 kg/h of ε-caprolactone into the 2.0 L continuous stirred-tank reactor, which was heated by an oil heat transfer unit operated at 185° C. (reaction medium at 180° C.). Separately from this feed, tin octoate/toluene (40 mg/ml) catalyst was introduced to maintain the total molar monomer/catalyst ratio within the range of 18,700 and 56,000. With a residence time of 20 to 40 min in the continuous stirred-tank reactor, the polymer and residual monomers were withdrawn from the reactor, mixed with a stream of 0.7 kg/h pure L-lactide, and fed to the double-jacketed static mixer-based plug flow reactor operated at the same temperature. With a total residence time within 30 to 90 min, the reaction was terminated using the same inhibitor and the polymer can be post-treated until its final form. The number average molecular weight analogues to the block copolymer was obtained. The nature of random PLA-co-PCL copolymer was revealed through DSC, where one glass transition temperature peak and one or likely none melting temperature peak were observed. The random nature of the polymer chains hinders the crystallization of polymer to a great extent. Unlike their analogue in linear form, this star-shape copolymer is amorphous unless subjected to very dedicated crystallization treatment or incorporated with specific additives.

1. A process of continuously manufacturing a poly(hydroxy acid) copolymer comprising:
copolymerizing at least two different monomers, at least one of the at least two different monomers being a cyclic ester of hydroxy acid, in the presence of at least one catalyst in a reactor system by ring-opening-polymerization to form the poly(hydroxy acid) copolymer,
a molar ratio of a total amount of the at least two different monomers to a total amount of the at least one catalyst applied during the ring-opening-polymerization being more than 10,000,
the reactor system comprising in series at least two polymerization reactors, at least one of the at least two polymerization reactors being a continuous stirred-tank reactor, a loop reactor or a plug flow reactor,
at least one of the at least two polymerization reactors comprising at least one selected from the group consisting of: at least one mixer and at least one heat transfer element,
reactor system comprising in series at least two different feeding points through each of which a monomer composition is fed into the reactor system, and
a first monomer composition being fed to the reactor system through one of the at least two feeding points being different from a second monomer composition being fed into the reactor system through at least one other of the at least two feeding points.

2. Pie process in accordance with claim 1, wherein a mixed monomer composition comprising a mixture of two or more of the at least two different monomers is fed through at least one of the at least two feeding points.

3. The process in accordance with claim 1, wherein:
a mixed monomer composition comprising a mixture of two or more of the at least two different monomers is fed through at least two of the at least two feeding points, or
a monomer composition comprising a first monomer is fed through at least one of the at least two feeding points and a monomer composition comprising a second monomer is fed through at least another one of the at least two feeding points, and
the first monomer has a different chemical nature than the second monomer.

4. The process in accordance with claim 1, wherein:
a first mixed monomer composition comprising a mixture of two or more of the at least two different monomers with a first molar ratio of the at least two different monomers is fed through one of the at least two feeding points and a second mixed monomer composition comprising a mixture of the at least two different monomers with a second molar ratio of the at least two different monomers is fed through another one of the at least two feedings points, and
the first molar ratio is different from the second molar ratio.

5. The process in accordance with claim 1, wherein:
the reactor system comprises in series at least three different feeding points through each of which a monomer composition is fed into the reactor system, and
a mixed monomer composition is fed, which contains two or more of the at least two different monomers, through at least one of the at least three different feeding points.

6. The process in accordance with claim 5, wherein:
a first mixed monomer composition comprising a mixture of two or more of the at least two different monomers with a first molar ratio of the at least two different monomers is fed through one of the at least three feeding points,
second mixed monomer composition comprising a mixture of a same two or more of the at least two different monomers with a second molar ratio of the at least two different monomers is fed through another one of the at least three feeding points, and
the first molar ratio is different from the second molar ratio.

7. The process in accordance with claim 5, wherein
first mixed monomer composition comprising a mixture of two or more of the at least two different monomers with a first molar ratio of the at least two different monomers is fed-through one of the at least three different feeding points,
a second mixed monomer composition comprising a mixture of a same two or more of the at least two different monomers with a second molar ratio of the at least two different monomers is fed through a second one of the at least three feeding points,
a third monomer composition comprising only one monomer or a mixture of a same two or more of the at least two different monomers with a third molar ratio of the at least two different monomers is fed through a third one of the at least three feeding points, and
the first molar ratio, the second molar ratio and the third molar ratio are different from each other.

8. The process in accordance with claim 1, wherein the reactor system comprises a first feeding point upstream of a most upstream reactor and a second feeding point downstream of the first feeding point and upstream of a next downstream reactor.

9. The process in accordance with claim 1, wherein:
the reactor system comprises a first reactor, a second reactor downstream of the first reactor, and a third reactor downstream of the second reactor,
a first feeding point is located upstream of the first reactor,
a second feeding point is located downstream of the first reactor and upstream of the second reactor, and
a third feeding point is located downstream of the second reactor and upstream of the third reactor.

10. The process in accordance with claim 1, wherein:
a first monomer composition is added to the reactor system upstream of a most upstream reactor, the first monomer composition comprising a mixture of two different monomers with a first molar ratio of the two different monomers,
a second monomer composition is added to a reactor downstream of the most upstream reactor, the second monomer composition comprising a mixture of a same two different monomers as the first monomer composition with a second molar ratio of the two different monomers, and
the second molar ratio is different from the first molar ratio.

11. The process in accordance with claim 10, wherein:
the reactor to which the second monomer composition is added is upstream of a most downstream reactor of the reactor system, or is at a location downstream of where the first monomer composition is added and upstream of a most downstream part of the reactor system,
a third monomer composition is added to the reactor system into a reactor downstream of the reactor to which the second monomer composition is added or into a reactor at a location downstream of where the second monomer composition is added,
the third monomer composition comprises a mixture of the same two different monomers as the first composition with a third molar ratio of the two different monomers, the third molar ratio being different from each of the first molar ratio and the second molar ratio, or the third monomer composition comprises only one of the two different monomers.

12. The process in accordance with claim 1, wherein at least one of the at least two different monomers is a cyclic ester selected from the group consisting of: lactide, glycolide, caprolactone, valerolactone, decanolactone, butyrolactone, dodecalactone, octanolactone and any combination of two or more of the aforementioned compounds or is/are preferably selected from the group consisting of L-lactide, D-lactide, meso-lactide, lactide racemic mixture, glycolide, ε-caprolactone, γ-caprolactone, δ-valerolactone, γ-valerolactone, 5-decanolactone, δ-decanolactone, δ-butyrolactone, δ-dodecalactone, 5-dodecalactone, δ-octanolactone, and any combination thereof.

13. The process in accordance with claim 1, wherein:
the reactor system comprises, in series seen from upstream to downstream at least one selected from the group consisting of:
at an upstream end a first continuous stirred-tank reactor or a first loop reactor and downstream thereof at least one of: a second continuous stirred-tank reactor, a second loop reactor and a plug flow reactor,
three continuous stirred-tank reactors,
three loop reactors,
a third continuous stirred-tank reactor and a plug flow section with two feeding points, and
a third loop reactor and a plug flow section with two feeding points, and
between two adjacent ones of the aforementioned reactors, a melt pump or a valve is provided.

14. The process in accordance with claim 1, wherein at least one reactor in the reactor system comprises at least one selected from the group consisting of: a static mixer, a dynamic mixer, and a combination of a static mixer and a heat transfer element.

15. The process in accordance with claim 1, wherein at least one rector in the reactor system comprises at least one selected from the group consisting of:
an impeller-type dynamic mixer,
a combined static mixer and heat transfer element.

16. The process in accordance with claim 1, wherein the poly(hydroxy acid) copolymer produced during the ring-opening-polymerization has at least one of: a weight average molecular weight of 10,000 to 200,000 g/mol as determined by gel permeation chromatography, and a yellowness index below 40.
